(19) United States
(12) Patent Application Publication
(10) Pub. No.: US 2011/0104475 A1
(43) Pub. Date: May 5, 2011

(54) SUBSTRATE UNIT FOR ELECTRONIC PAPER

(75) Inventors: Soon Hyung Kwon, Seoul (KR); Won Keun Kim, Osan-Si (KR); Jeong In Han, Seoul (KR); Chul Jong Han, Seoul (KR)

(73) Assignees: Korea Electronics Technology Institute; SK Telecom Co., Ltd.

(21) Appl. No.: 12/914,582

(22) Filed: Oct. 28, 2010

(30) Foreign Application Priority Data
Nov. 2, 2009 (KR) 10-2009-0104972

(51) Int. Cl. B32B 5/16; B32B 9/04; B32B 27/00; B32B 17/06

(52) U.S. Cl. 428/323; 428/446; 428/421; 428/500; 428/426; 428/411.1

(57) ABSTRACT

A substrate unit for an electronic paper is provided. The substrate unit for the electronic paper includes a substrate; an electrode formed on the substrate; and a hydrophobic polymer layer formed on at least one of an outer side of the substrate and the electrode.

### CROSS-REFERENCE TO RELATED APPLICATION(S) AND CLAIM OF PRIORITY

The present application claims the benefit under 35 U.S.C. §119(a) to a Korean patent application filed in the Korean Intellectual Property Office on, and assigned Serial No. 10-2009-0104972, the entire disclosure of which is hereby incorporated by reference.

### TECHNICAL FIELD OF THE INVENTION

The present invention relates generally to a substrate unit. More particularly, the present invention relates to a substrate unit for an electronic paper.

### BACKGROUND OF THE INVENTION

As various display devices are demanded, an electronic paper technique is developed as a display device which can provide clearer images for a longer time with a low driving power and be fabricated thin and flexibly. The electronic paper, which is a kind of reflective display, has outstanding optical features with high resolution like conventional papers and inks, wider viewing angle, and bright background. The electronic paper can be implemented on any substrate such as plastic, metal, paper, and glass, and does not require a backlight power having a memory feature because the images still remain after the power off. Thus, the electronic paper can achieve cost reduction and lightweight, which is why many researches are conducted on the electronic paper.

The electronic paper technique applied to the present invention represents colors by applying voltages to particles in a certain region using fast electrophoretic effect of charged microparticles of powers according to an electric field and electrostatically migrating the particles. After the movement, when the voltage is removed, the particles do not change their locations at any electrode owing to the memory effect. In result, the images do not disappear and the effect similar to inks printed on the paper can be attained. That is, the electronic paper display, which does not emit its own light, causes even lower visual fatigue. A panel of the electronic paper is quite flexible enough to be bent. Since the electronic paper does not need its own light emitting unit such as backlight unit, very thin electronic papers can be fabricated. In this regard, the electronic paper is drawing much attention as a future flat display technology. In addition, since the image displayed once stays for a long time unless the panel is reset as discussed above, power consumption of the electronic paper is very low. As the power is consumed only to change the image, the electronic paper can be widely used as a portable display device. In particular, the low price based on the simplified process and the low-priced materials contributes to popularization of the electronic paper panel.

Meanwhile, unlike general displays, a charged particle type electronic paper is subject to absorption of the particles in the panel because of the electrostatic phenomenon of the particles and the substrate and the environmental effects inside the panel. When the electronic paper is used as an outdoor display, the external environment such as dusts and organic materials causes various dusts and stains on the outer surface of the panel and thus degrades the display quality.

### SUMMARY OF THE INVENTION

To address the above-discussed deficiencies of the prior art, it is a primary aspect of the present invention to provide a substrate unit for an electronic paper for preventing charged particles from absorbing to the substrate inside a panel and for preventing dusts and foreign substances for absorbing to the outer surface by forming hydrophobic polymer layers inside and outside the electronic paper substrate.

According to one aspect of the present invention, a substrate unit for an electronic paper includes a substrate; an electrode formed on the substrate; and a hydrophobic polymer layer formed on at least one of an outer side of the substrate and the electrode.

The hydrophobic polymer layer may include an electrode hydrophobic polymer layer formed on the electrode; and a substrate hydrophobic polymer layer formed in the outer side of the substrate.

An insulating layer may be formed between the electrode and the hydrophobic polymer layer.

The substrate hydrophobic polymer layer may be formed with a low-reflective material.

The hydrophobic polymer layer may be formed with a material selected from polystyrene (PS), polyacrylonitrile (PAN), silica, poly ethylene oxide, poly tetrafluoro ethylene, TiO₂, polyvinyl chloride, poly ethylene, and poly propylene.

A size of a polymer particle forming the hydrophobic polymer layer may be smaller than 100 nm.

The substrate may be formed of a glass or a synthetic resin film.

The insulating layer may be formed with an organic or inorganic material.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a sectional view of an electronic paper including a substrate unit for the electronic paper according to an exemplary embodiment of the present invention; and

FIG. 2 is a sectional view of the substrate unit for the electronic paper of FIG. 1.

Throughout the drawings, like reference numerals will be understood to refer to like parts, components and structures.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

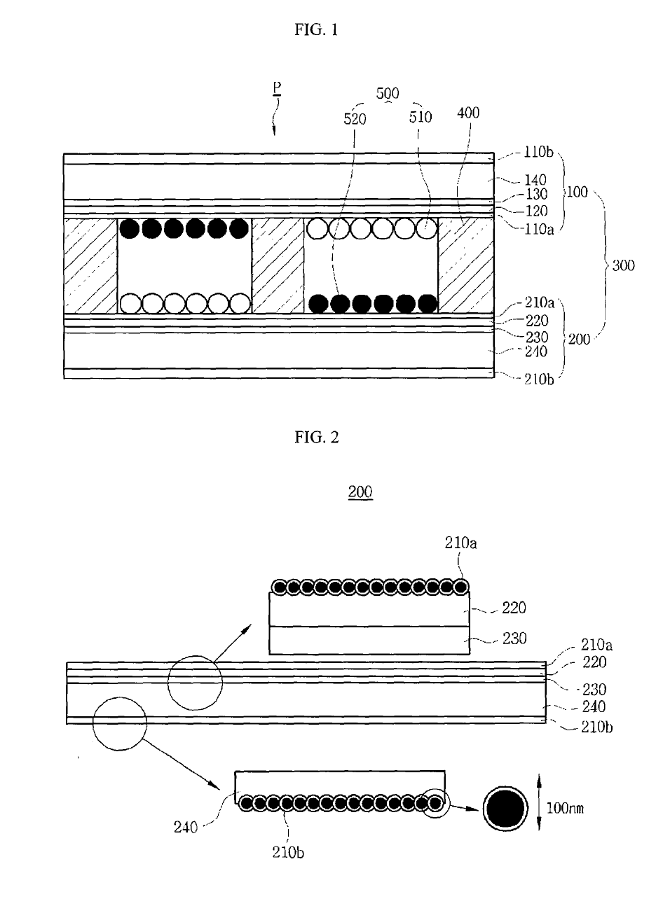

FIG. 1 is a sectional view of an electronic paper P including a substrate unit 300 for the electronic paper according to an exemplary embodiment of the present invention. FIG. 2 is a sectional view of a second substrate unit 200 for the electronic paper of FIG. 1.

Referring to FIGS. 1 and 2, the electronic paper P can include the substrate unit 300 for the electronic paper. The electronic paper substrate unit 300 can include a first electronic paper substrate unit 100, and a second electronic paper substrate unit 200 which is apart from the first electronic paper substrate unit 100.

The first electronic paper substrate unit 100 and the second electronic paper substrate unit 200 can be fabricated in the same or similar form. Hereafter, the second electronic paper substrate unit 200 is mainly explained to ease the understanding.

The second electronic paper substrate unit 200 includes a second substrate 240. Material of the second substrate 240 can employ a glass or a synthetic resin film. The synthetic resin film can be selected from PET, PES, PC, PMMA, PEN, PI, and FRP.

The second electronic paper substrate unit 200 includes a second electrode 230 formed on the surface of the second substrate 240. Since the second substrate 240 can employ an opaque substrate, the second electrode 230 can use chromium, aluminum, and copper electrode.

By contrast, a first electrode 130 can be formed in one direction with a certain width by coating a transparent metal layer on the surface of a first substrate 140 and using lithography. The metal layer used for the first electrode 130 can mostly employ a transparent material.

The second electronic paper substrate unit 200 can include a second insulating layer 220 formed on the second electrode 230. The second insulating layer 220 can be formed with at least one selected from the group comprising polycarbonate, polyethylene terephthalate, and polythersulfone.

The second insulating layer 220 can employ a stacked insulating layer including at least one selected from the group comprising SiO₂, SiNx, Al₂O₃, and Ta₂O₃. The material used in the second insulating layer 220 can be organic or inorganic. As such, by means of the second insulating layer 220 formed on the second electrode 230, it is possible to prevent the charged electrons in the charged particles 500 from leaking to the electrode.

The charged particles 500 can be formed variously. For example, the charged particles 500 can include white charged particles 510. Also, the charged particles 500 can include black charged particles 520. The charged particles 500 are not limited to those particles, and include other charged particles of various colors.

The second electronic paper substrate unit 200 includes a second hydrophobic polymer layer (not shown) formed on at least one of the outer side of the second substrate 240 and the second electrode 230. The second hydrophobic polymer layer can include a second electrode hydrophobic polymer layer 210a formed on the second electrode 230. The second hydrophobic polymer layer can also include a second substrate hydrophobic polymer layer 210b formed on the outer side of the second substrate 240.

Since the charged particle type electronic paper is subject to the frequent particle absorption inside the panel, to prevent such absorption, the second electrode hydrophobic polymer layer 210a can be formed on the second insulating layer 220. Notably, the second electrode hydrophobic polymer layer 210a may be formed on the second insulating layer 220, and directly on the second electrode 230 without the second insulating layer 220. The second electrode hydrophobic polymer layer 210a formed on the second insulating layer 220 can prevent the absorption of the charged particles 500 to the second insulating layer 220.

Meanwhile, the second substrate hydrophobic polymer layer 210b prevents decrease of a reflection ratio and a contrast ratio. Particularly, when the electronic paper is used as an outdoor display, various dusts and stains on the outer surface of the panel can degrade the display quality. This problem in the reflective display panel such as electronic paper can block the flow of the external light and degrade the reflection ratio and the contrast ratio. In case of the electronic paper having a touch function, when the outside of the panel is stained with organic matters such as finger prints, the second substrate hydrophobic polymer layer 210b can prevent the degradation of the reflection ratio and the contrast ratio.

Meanwhile, nano-size polymer particles used in the second hydrophobic polymer layer is formed by spreading a material such as polystyrene (PS), polyacrylonitrile (PAN), silica, poly ethylene oxide, poly tetrafluoro ethylene, TiO₂, polyvinyl chloride, poly ethylene, and poly propylene. The coating method of the second hydrophobic polymer layer can adopt various methods such as dipping, spin coating, and bar coating. Mostly, the dipping into a dispersion solution is used.

Hereafter, the second hydrophobic polymer layer formed using the dipping is mainly described to ease the understanding.

The size of the polymer particle forming the second hydrophobic polymer layer can be smaller than 100 nm. When the size of the polymer particle exceeds 100 nm, surface uniformity of the second hydrophobic polymer layer can be irregular. Hence, as the charged particles 500 touch the second hydrophobic polymer layer, the tribocharge characteristics are irregular and thus the movement of the charged particles 500 can vary. Further, the varying movement of the charged particles 500 can degrade the quality of the electronic paper P.

By contrast, when the size of the polymer particle falls below 100 nm, the tribocharge characteristics of the charged particles 500 improve and thus the quality of the electronic paper P can be enhanced.

The second electronic paper substrate unit 200 can include a partition 400 formed on the second electrode 230. After the second electrode 230 is formed, the partition 400 can be formed on the surface of the second electrode 230 as a matrix type.

The partition 400 can be formed by printing and etching a thin film in the upper side of the second electrode 230. The partition 400 can be high enough to equal one time through third times of a diameter of the charged particle 500, to be explained. This is to arrange the charged particles 500 stuffed into a cell formed by the partition 400 in one through three layers. The shape of the partition 400 can be honeycombed.

Next, the charged particles 500 which are charged or can be charged are supplied to each cell between the partitions 400 formed through the above process. Using a particle feeder, the charged particles 500 are dispersed evenly to stack the charged particles at least over the height of the partition 400.

In the fabrication of the electronic paper P, the second electrode 230 can be formed on the second substrate 240 and the partition 400 can be formed on the second electrode 230. The partition 400 can be formed using the etching as stated above.

Next, the second insulating layer 220 can be formed between the partitions 400. In so doing, the second insulating layer 220 can be formed as described above, or not. Hereafter, explanations are centered on the formation of the second insulating layer 220 to ease the understanding.

When the second insulating layer 220 is formed between the partitions 400, the second electrode hydrophobic polymer layer 210a can be formed in the upper side of the second insulating layer 220. The second substrate hydrophobic polymer layer 210b can be formed in the outer side of the second substrate 240.

After the second electrode hydrophobic polymer layer 210a is formed, the charged particles 500 can fill the cell C formed between the partitions 400. The charged particles 500 can fill the cell C in various manners.

For instance, the charged particles 500 can be dispersed using the particle feeder as mentioned above. The charged particles 500 can stuff into the cell C using a Doctor blade.

When the charged particles 500 are completely filled, the charged particles 500 absorbed or disposed on the partition 400 can be removed. The removal can use the Doctor blade or a plate with adhesives sprayed.

Next, the first electrode electronic paper substrate unit 100 can be fabricated. In so doing, after the first electrode 130 is formed on a first substrate 140, a first insulating layer 120 can be formed on the first electrode 130.

A first electrode hydrophobic polymer layer 110a can be formed on the first insulating layer 120. A first substrate hydrophobic polymer layer 110b can be formed in the outer side of the first substrate 140.

Next, the first electronic paper substrate unit 100 is combined with the partition 400 by spreading a special adhesive in one side of the first electronic paper substrate unit 100, to thus fabricate the electronic paper P.

In exemplary embodiments of the present invention, the first hydrophobic polymer layer and the second hydrophobic polymer layer (not shown) are formed to prevent the absorption of the charged particles 500 inside the first substrate 140 and the second substrate 240 and to prevent the absorption of the external dusts or foreign matters to the surfaces of the first substrate 140 and the second substrate 240. Therefore, it is possible to avoid the image degradation of the display and to prevent the absorption of the foreign substances such as finger prints due to the touch, to the outer surface of the substrate.

By forming the hydrophobic polymer layers, the absorption of the charged particles inside the substrate can be prevented and the absorption of the external dusts or foreign matters to the surfaces of the substrate can be prevented. Consequently, it is possible to avoid the image degradation of the display, and to prevent the smudge of the foreign substances such as finger prints due to the human touch, in the outer surface of the substrate.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A substrate unit for an electronic paper, comprising:
a substrate;
an electrode formed on the substrate; and
a hydrophobic polymer layer formed on at least one of an outer side of the substrate and the electrode.

2. The substrate unit of claim 1, wherein the hydrophobic polymer layer comprises:
an electrode hydrophobic polymer layer formed on the electrode; and
a substrate hydrophobic polymer layer formed in the outer side of the substrate.

3. The substrate unit of claim 1, wherein an insulating layer is formed between the electrode and the hydrophobic polymer layer.

4. The substrate unit of claim 2, wherein the substrate hydrophobic polymer layer is formed with a low-reflective material.

5. The substrate unit of claim 1, wherein the hydrophobic polymer layer is formed with a material selected from polystyrene (PS), polyacrylonitrile (PAN), silica, poly ethylene oxide, poly tetrafluoro ethylene, TiO₂, polyvinyl chloride, poly ethylene, and poly propylene.

6. The substrate unit of claim 1, wherein a size of a polymer particle forming the hydrophobic polymer layer is smaller than 100 nm.

7. The substrate unit of claim 1, wherein the substrate is formed of a glass or a synthetic resin film.

8. The substrate unit of claim 2, wherein the insulating layer is formed with an organic or inorganic material.

9. The substrate unit of claim 8, wherein the insulating layer is deposited with at least one selected from a group comprising SiO₂, SiNx, Al₂O₃, and Ta₂O₃.

10. The substrate unit of claim 1, further comprising:
a partition formed on the hydrophobic polymer layer.

11. The substrate unit of claim 10, wherein a plurality of partitions is formed, and
the partitions are apart from each other at certain intervals and formed on a second hydrophobic polymer layer in a matrix type.

12. The substrate unit of claim 1, wherein the hydrophobic polymer layer is formed using dipping, spin coating, or bar coating process.
